(19) United States
(12) Patent Application Publication
(10) Pub. No.: US 2011/0295388 A1
(43) Pub. Date: Dec. 1, 2011

(54) LADDER PROGRAM EDITION DEVICE

(75) Inventors: Hideaki Iwata, Tokyo (JP); Terumasa Yasui, Tokyo (JP); Hirofumi Kai, Tokyo (JP); Hiroshi Hamazaki, Tokyo (JP); Tomo Horikawa, Tokyo (JP); Takayuki Yamaoka, Tokyo (JP)

(73) Assignee: MITSUBISHI ELECTRIC CORPORATION, Chiyoda-ku, Tokyo (JP)

(21) Appl. No.: 13/147,776

(22) PCT Filed: Feb. 4, 2009
(86) PCT No.: PCT/JP2009/051887

§ 371 Date: Aug. 3, 2011

(51) Int. Cl. G05B 19/05

(52) U.S. Cl. 700/18

(57) ABSTRACT

When constituting a ladder program edition device that edits a ladder diagram, there is provided an edit control unit that generates data of a logical expression corresponding to a logical structure of an input condition and an output condition in a ladder diagram based on an arrangement of circuit elements in a ladder diagram, sets circuit elements that specify the input condition as one circuit unit of one input and one output for each input condition based on the data of the above logical expression, and connects output ends of circuit units to be connected in parallel with each other in the ladder diagram. With this configuration, generation of a syntactically erroneous ladder diagram is prevented.

### TECHNICAL FIELD

The present invention relates to a ladder program edition device.

### BACKGROUND ART

In a ladder program that determines a control sequence by a sequencer in a form of a ladder diagram, two bus bars (a plus bus bar and a minus bus bar) that symbolically express power are drawn with an interval between these bus bars, and a logic circuit that uses a relay, a coil or the like is drawn in a ladder shape so as to connect these two bus bars. Usually, when generating and editing such a ladder program, a ladder program edition device is used.

For example, Patent Literature 1 describes a ladder program edition device (a ladder diagram edition device) that displays plural auxiliary lines in a ladder diagram display region on a screen in a grid shape and generates a ladder diagram by arranging circuit elements (constituent elements) by using a cell surrounded by the auxiliary lines as a unit. This ladder program edition device is configured to be able to change a vertical or lateral width of an arbitrary cell such that a ladder diagram can be efficiently displayed.

When generating a ladder program by using a ladder program edition device, a programmer generates a ladder diagram by the ladder program edition device after designing in advance a desired logic circuit (a relay circuit). That is, when generating a ladder program, logic designing of a ladder diagram and arrangement designing of a circuit in the ladder diagram are made. Thereafter, a ladder diagram generated by the ladder program edition device is converted into an object code that can be executed by a sequencer by the ladder program edition device, for example.

Patent Literature 1: Japanese Patent Application Laid-open No. 2005-92807

### DISCLOSURE OF INVENTION

### Problem to be Solved by the Invention

According to conventional ladder program edition devices, when connecting circuit elements (this means basic circuit elements that cannot be unified) in series with each other in a ladder diagram, a connection relationship between the circuit elements can be assigned; however, a connection relationship cannot be assigned when connecting one circuit element to a circuit element that is far from the circuit element because of an arrangement rule or when connecting circuit elements in parallel with each other. Therefore, in this case, a programmer performs an operation of drawing a connection line between circuit elements on a screen. In this case, because a connection line can be also freely drawn at an incorrect position where a logic circuit cannot be established, there is a possibility of generating a syntactically erroneous ladder diagram. Because a syntactic error in a ladder diagram requires correction afterwards, this increases load when generating ladder programs.

The present invention has been achieved in view of the above problems, and an object of the present invention is to obtain a ladder program edition device that can easily prevent generation of a syntactically erroneous ladder diagram.

### Means for Solving Problem

A ladder program edition device of the present invention that causes a plus bus bar and a minus bus bar in a ladder diagram to be displayed on a screen of a display unit, causes a plurality of auxiliary lines to be vertically and laterally displayed in a region between the plus bus bar and the minus bus bar, thereby partitioning the region into a plurality of cells, causes circuit elements that constitute a ladder diagram to be symbolically displayed in mutually separate cells, and edits a ladder diagram in which at least one input condition corresponds to one output condition, includes: an input unit that inputs a command related to editing of the ladder diagram; and an edit control unit that arranges route elements in cells on the screen of the display unit based on a command from the input unit, generates data of a logical expression corresponding to a logical structure in the ladder diagram based on an arrangement of the circuit elements, specifies circuit elements to be connected in parallel with each other in the ladder diagram based on the data of the logical expression, and connects output ends of the circuit elements by a connection line.

### Effects of Invention

According to the ladder program edition device of the present invention, circuit elements to be connected in parallel with each other in a ladder diagram are specified based on data of a logical expression corresponding to a logical structure in the ladder diagram, and output ends of these circuit elements are automatically connected to each other by a connection line. Therefore, generation of a syntactically erroneous ladder diagram can be easily prevented. Consequently, according to the ladder program edition device of the present invention, load of generating ladder programs can be reduced.

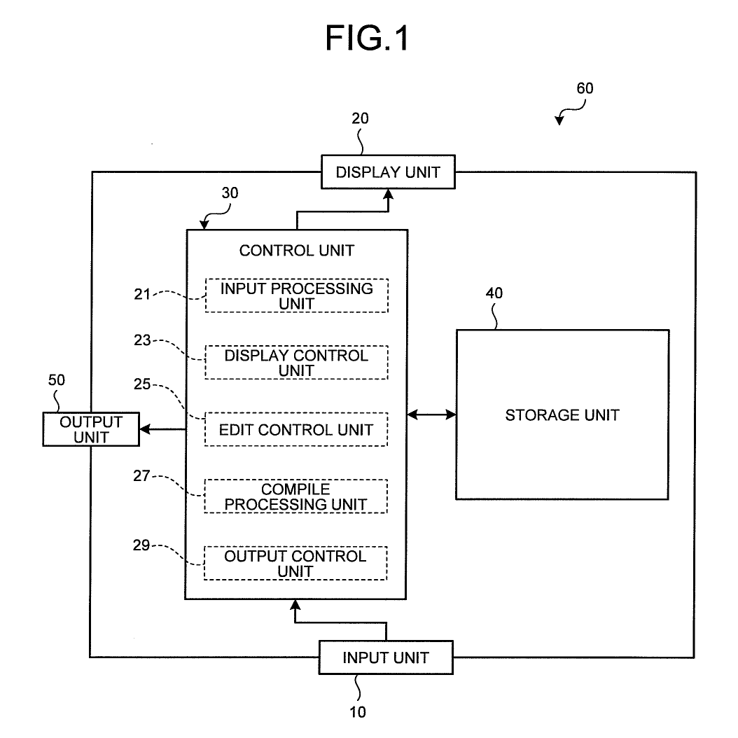

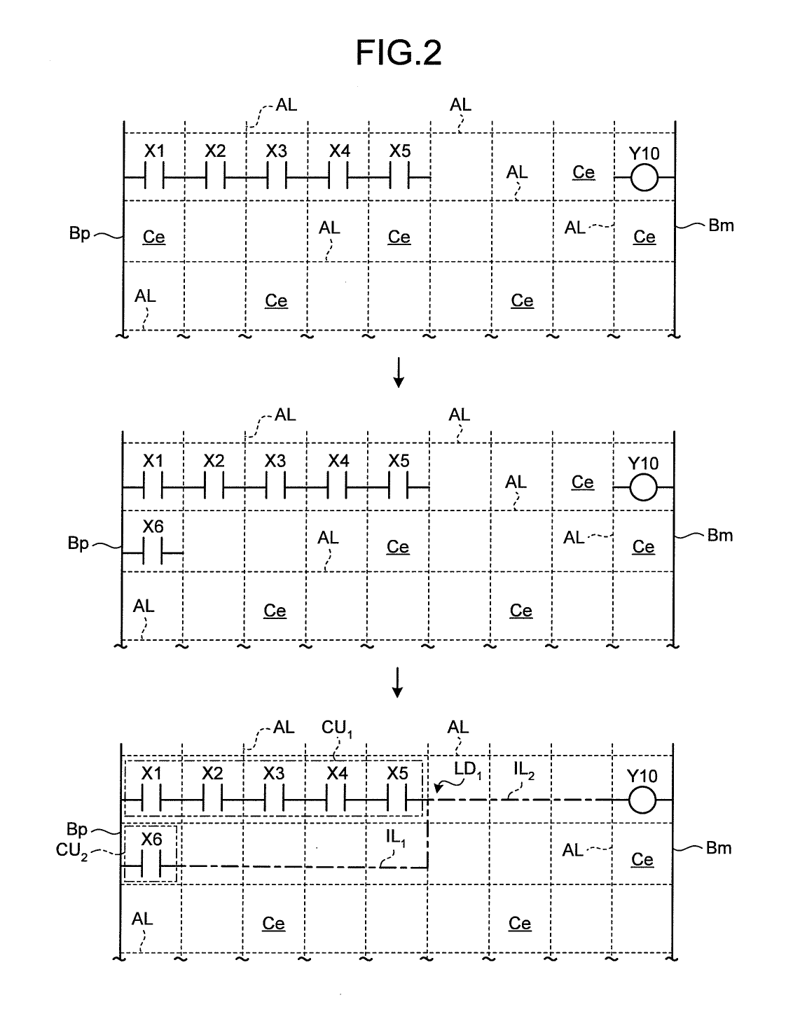

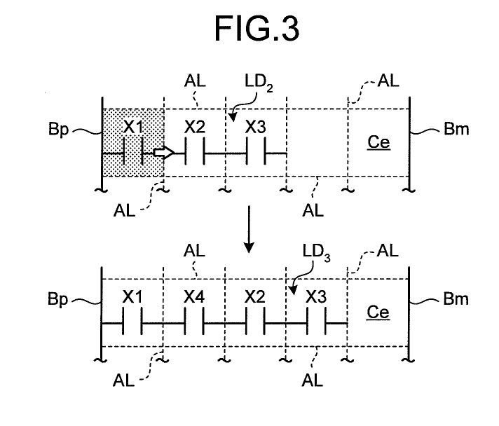

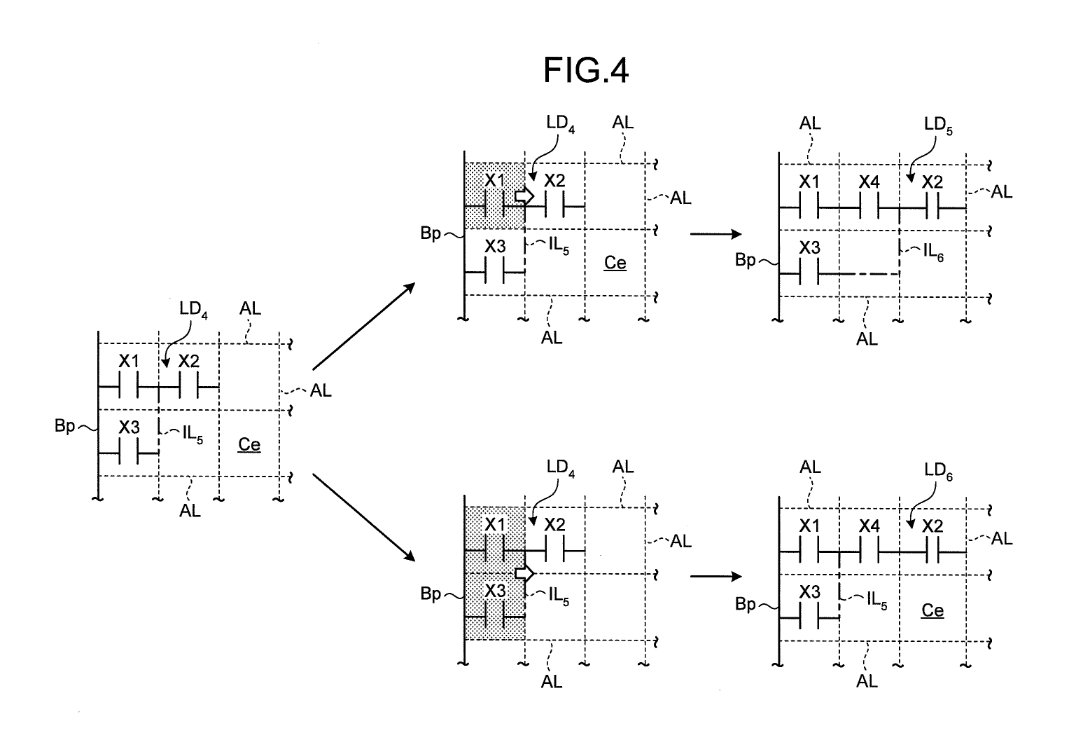

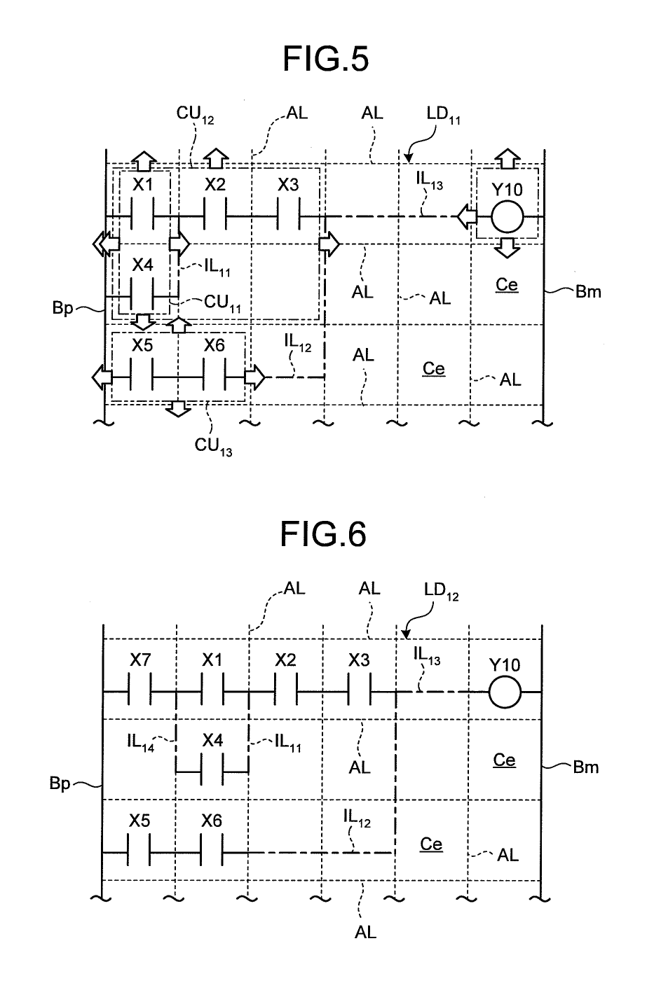

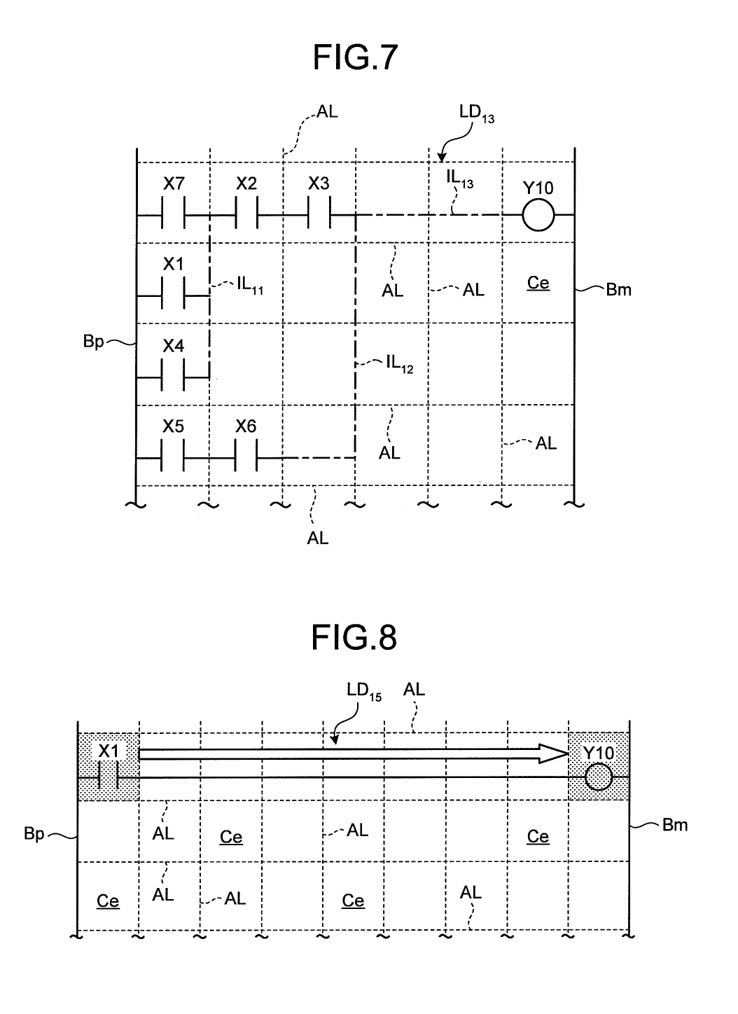

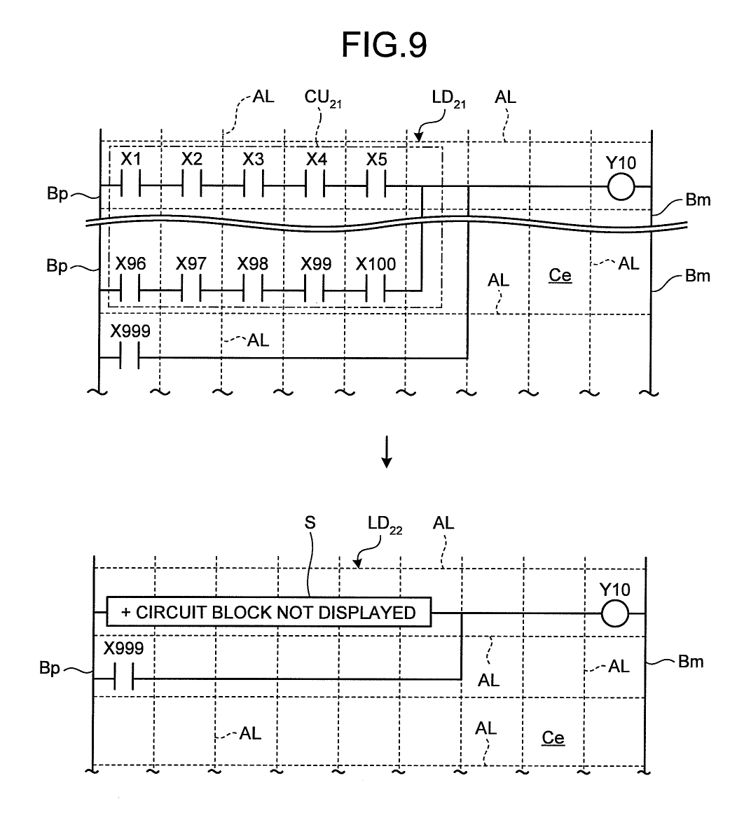

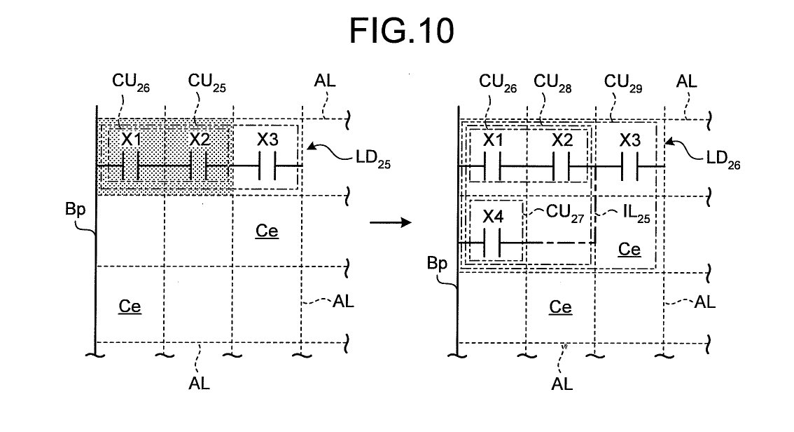

### BRIEF DESCRIPTION OF DRAWINGS

[FIG. 1] FIG. 1 is a schematic block diagram of an example of a ladder program edition device according to the present invention.

[FIG. 2] FIG. 2 is a schematic diagram, shown by a transition of a screen display of a display unit, of an example of a procedure when a ladder diagram in which two input conditions correspond to one output condition is edited by the ladder program edition device according to the present invention.

[FIG. 3] FIG. 3 is a schematic diagram of an example of a screen display when a new circuit element is inserted into a ladder diagram in the middle of editing by the ladder program edition device according to the present invention having an arrangement update function.

[FIG. 4] FIG. 4 is a schematic diagram of another example of a screen display when a new circuit element is inserted into a ladder diagram in the middle of editing by the ladder program edition device according to the present invention having an arrangement update function.

[FIG. 5] FIG. 5 is a schematic diagram of an example of a screen display when a new circuit element is inserted into a ladder diagram in the middle of editing by the ladder program edition device according to the present invention having an insertion guide function.

[FIG. 6] FIG. 6 is a schematic diagram of an example of a screen display after a new circuit element is inserted into a ladder diagram in the middle of editing by the ladder program edition device according to the present invention having an insertion guide function.

[FIG. 7] FIG. 7 is a schematic diagram of another example of a screen display after a new circuit element is inserted into a ladder diagram in the middle of editing by the ladder program edition device according to the present invention having an insertion guide function.

[FIG. 8] FIG. 8 is a schematic diagram of an example of an edit-position shifting mode of the ladder program edition device according to the present invention having a skip function.

[FIG. 9] FIG. 9 is a schematic diagram, shown by a transition of a screen display of a display unit, of an example of an omission display function of the ladder program edition device according to the present invention having the omission display function.

[FIG. 10] FIG. 10 is a schematic diagram of an example of a transition of a screen display of the ladder program edition device according to the present invention having a circuit-unit assignment function.

### EXPLANATIONS OF LETTERS OR NUMERALS

10 input unit

20 display unit

25 edit control unit

30 control unit

40 storage unit

50 output unit

60 ladder program edition device

Bp plus bus bar

Bm minus bus bar

AL auxiliary line

Ce cell

X1 to X6, Y10 circuit element

CU₁, CU₁₁ to CU₁₃, CU₂₁, CU₂₂, CU₂₅ to CU₂₉ circuit unit

IL₁, IL₂, IL₅, IL₆, IL₁₁ to IL₁₄, IL₂₅ connection line

LD₁ to LD₆, LD₁₁ to LD₁₃, DL₁₅, LD₂₁, LD₂₂, LD₂₅, LD₂₆ ladder diagram

### BEST MODE(S) FOR CARRYING OUT THE INVENTION

Exemplary embodiments of a ladder program edition device according to the present invention will be explained below in detail with reference to the accompanying drawings. The present invention is not limited to the embodiments.

### First Embodiment

FIG. 1 is a schematic block diagram of an example of the ladder program edition device according to the present invention. A ladder program edition device 60 shown in FIG. 1 includes an input unit 10, a display unit 20, a control unit 30, a storage unit 40, and an output unit 50. The ladder program edition device 60 causes a predetermined number of circuit elements to be symbolically displayed respectively on a screen (not shown) of the display unit 20 corresponding to a command that is input from the input unit 10, and edits (including new generation) a ladder diagram in which at least one input condition corresponds to one output condition.

The input unit 10 that constitutes the ladder program edition device 60 is configured by using a keyboard and a mouse, for example, and inputs a command related to editing of a ladder diagram to the control unit 30 based on an operation by a user. The display unit 20 is configured by using a display device such as a liquid-crystal display device, for example, and displays a menu screen, a ladder diagram or the like by operating under a control of the control unit 30.

The control unit 30 performs an operation control to edit a ladder diagram on a screen of the display unit 20, an operation control to store data related to an edited ladder diagram into the storage unit 40, and an operation control to output data that is stored in the storage unit 40 from the output unit 50. To perform these operation controls, the control unit 30 has an input processing unit 21, a display control unit 23, an edit control unit 25, a compile processing unit 27, and an output control unit 29.

The input processing unit 21 allocates a command that is input from the input unit 10, to the display control unit 23, the edit control unit 25, the compile processing unit 27, or the output control unit 29, based on a content of the command. The display control unit 23 performs operation controls related to display of images other than a ladder diagram among screen displays by the display unit 20, for example, images of an initial screen when the ladder program edition device 60 is started, a guide screen when the compile processing unit 27 is caused to perform compile processing, and a guide screen when predetermined data is output from the output unit 50.

The edit control unit 25 performs operation controls related to edit and display of a ladder diagram on the screen of the display unit 20. For example, the edit control unit 25 causes a plus bus bar and a minus bus bar in a ladder diagram to be displayed on the screen based on a command from the input unit 10 and causes plural auxiliary lines to be vertically and laterally displayed in a region between the plus bus bar and the minus bus bar, thereby partitioning the region into plural cells, causes an edit menu to be displayed on the screen when editing a ladder diagram, and causes a predetermined circuit element to be symbolically displayed in a predetermined cell based on a command from the input unit 10. Further, the edit control unit 25 generates data of a logical expression corresponding to a logical structure of an input condition and an output condition in a ladder diagram, and automatically draws a connection line at a predetermined position in the ladder diagram by using the data.

To perform these operation controls and processing, the edit control unit 25 generates and stores into the storage unit 40, information (hereinafter, “position information”) that can specify the arrangement of circuit elements in a ladder diagram, such as coordinate data of each of the cells, and cell identification data that specifies a cell based on a cell number in a cell row and an arrangement number that is attached to each cell, and specifies the arrangement of each circuit element and a drawing position of a connection line by using the position information. The edit control unit 25 also stores data of an edited ladder diagram and data of the logical expression into the storage unit 40.

When a command that instructs compiling is input from the input unit 10 and also when this command is allocated to the compile processing unit 27 by the input processing unit 21, the compile processing unit 27 reads data of a ladder diagram that the edit control unit 25 has edited and stored into the storage unit 40 or data of the logical expression described above from the storage unit 40, converts this data into an object code, and stores the object code into the storage unit 40. When a ladder program edition device is configured such that the compile processing unit 27 generates an object code based on data of the logical expression, software development in the ladder program edition device is facilitated.

When a command that instructs outputting data is input from the input unit 10 and also when this command is allocated to the output control unit 29 by the input processing unit 21, the output control unit 29 reads an object code from the storage unit 40 and sends this object code to the output unit 50, and controls an operation of the output unit 50 to output the object code.

The storage unit 40 stores a control program for the control unit 30, data of a logical expression obtained by the edit control unit 25, data of a ladder program that the edit control unit 25 has edited, the object code described above or the like. The output unit 50 is configured by a printer, an auxiliary storage device, a transmitting device (all not shown) connected to a network, for example, and outputs data, an object code or the like of the ladder diagram by operating under a control of the output control unit 29.

In the ladder program edition device 60 having the constituent elements 10, 20, 30, 40, and 50 described above, a predetermined command is input from the input unit 10 after the device is started, a plus bus bar and a minus bus bar in a ladder diagram are caused to be displayed on the screen of the display unit 20 under operation control by the edit control unit 25, and plural auxiliary lines are caused to be vertically and laterally displayed in a region between the plus bus bar and the minus bus bar, thereby partitioning the region into plural cells. Thereafter, the ladder diagram is edited in a procedure shown in FIG. 2, for example.

FIG. 2 is a schematic diagram, shown by a transition of a screen display of a display unit, of an example of a procedure when a ladder diagram in which two input conditions correspond to one output condition is edited (newly generated) by the ladder program edition device. First, in the example shown in FIG. 2, circuit elements X1 to X5 that specify one of the two input conditions are sequentially arranged (displayed) in predetermined cells Ce, respectively (see the top diagram in FIG. 2), under operation control of the edit control unit 25 (see FIG. 1). A circuit element Y10 that indicates the output condition is arranged (displayed) in a predetermined cell Ce. In FIG. 2, a plus bus bar Bp and a minus bus bar Bm are expressed by solid lines, respectively, and each auxiliary line AL is expressed by a broken line.

Each of the circuit elements X1 to X5 is a contact that is symbolically displayed by two vertical lines arranged with a distance therebetween and by two lateral lines in total one of which extends from one vertical line to the side of the plus bus bar Bp and the other of which extends from the other vertical line to the side of the minus bus bar Bm. The circuit element Y10 is a coil that is symbolically displayed by a circle and by two lateral lines in total one of which extends from the circle to the side of the plus bus bar Bp and the other of which extends from the circle to the side of the minus bus bar Bm. The circuit elements X1 to X5 are sequentially arranged in left alignment from the cell Ce that is nearest to the plus bus bar Bp to another cell Ce that is at the minus bus bar Bm side in a cell row that is positioned at a top in a region between the plus bus bar Bp and the minus bus bar Bm. The circuit element Y10 is arranged in right alignment in the cell Ce that is nearest to the minus bus bar Bm in this cell row.

The lateral lines of the symbolically displayed circuit elements X1 to X5 and Y10 express connection lines, and each of the circuit elements X1 to X5 and Y10 has a same width as that of each of the cells Ce. The height of each lateral lines of each of the circuit elements X1 to X5 and Y10 (the height within each of the cells Ce) is the same. Therefore, when the circuit elements X1 to X5 are arranged as described above, the circuit elements X1 to X5 that are connected in series with each other are connected to the plus bus bar Bp. Further, the circuit element Y10 is directly connected to the minus bus bar Bm. Characters of “X1” to “X6” and “Y10” in the drawing are drawn not only as reference signs, but also are displayed in an actual ladder diagram to identify circuit elements.

Next, as shown in the central diagram in FIG. 2, a circuit element X6 that specifies a remaining input condition is symbolically arranged (displayed) in a predetermined cell Ce, that is, the cell Ce that is nearest to the plus bus bar Bp among the cells Ce that constitute a cell row at a lower layer side of the cell row in which the circuit elements X1 to X5 and Y10 are arranged (this means a side where a ladder diagram of which a program-execution order is later is drawn), specifically, among the cells Ce that constitute a cell row immediately beneath the cell row, under operation control of the edit control unit 25. The circuit element X6 is also a contact like the circuit elements X1 to X5, and is directly connected to the plus bus bar Bp.

The edit control unit 25, while arranging the circuit elements X1 to X5, Y10, and X6 into predetermined cells Ce, respectively, generates data of a logical expression corresponding to a logical structure of input conditions and an output condition in a ladder diagram LD₁ (see the bottom diagram in FIG. 2) based on the arrangement of the circuit elements X1 to X5, Y10, and X6. When a command that instructs drawing a connection line is input from the input unit 10, the edit control unit 25 specifies circuit elements to be connected in parallel with each other and automatically draws a connection line that connects output ends of the circuit elements, based on the data of the logical expression. Specifically, the edit control unit 25 sets each circuit element that specifies an input condition in the logical expression described above as one circuit unit of one input and one output for each input condition, specifies the circuit elements to be connected in parallel with each other by specifying circuit units to be connected in parallel with each other, and automatically draws a connection line that connects output ends of the circuit elements.

In the example shown in FIG. 2, the circuit elements X1 to X5 are set as one circuit unit CU₁, and at the same time, the circuit element X6 is set as another circuit unit CU₂, and a connection line IL₁ that connects an output end of the circuit unit CU₁ and an output end of the circuit unit CU₂ is automatically drawn. A connection line IL₂ that connects the output end of the circuit unit CU₁ and an input end of the circuit element Y10 is also automatically drawn by the edit control unit 25.

The data of the above logical expression generated by the edit control unit 25 corresponds to a logical expression that expresses an individual circuit element as one term by specifying this circuit element by a unique identifier, for example. In the logical expression, among terms that specify input conditions in a ladder diagram, terms that correspond to circuit elements that are connected in parallel with each other in the ladder diagram are connected by a first operator, and terms that correspond to circuit elements that are connected in series with each other in the ladder diagram are connected by a second operator. When specifying a priority order on a logical structure of terms that correspond to plural circuit elements that specify one input condition, the terms corresponding to the plural circuit elements are enclosed by punctuation marks. The logical structure of the ladder diagram LD₁ shown in FIG. 2 can be expressed by the following logical expression (i), for example.

[Expression 1]

(X1 and X2 and X3 and X4 and X5) or X6→Y10 (i)

In the above logical expression (i), the circuit elements X1 to X6 and Y10 in the ladder diagram LD₁ are specified by unique identifiers X1 to X6 and Y10 for the circuit elements X1 to X6 and Y10, respectively to prepare terms. The terms X1 to X5 corresponding to the circuit elements X1 to X5 that specify one input condition are regarded as one term by enclosing the terms X1 to X5 by punctuation marks, specifically by parentheses, thereby specifying a priority order on the logical structure. Because a circuit element that specifies the other input condition is only one element of X6, the term X6 that corresponds to the circuit element X6 is not enclosed by punctuation marks. For the first operator, “or” is used, and “and” is used for the second operator. A term Y10 corresponding to the circuit element Y10 that indicates the output condition in the ladder diagram LD₁ and the terms X1 to X6 that indicate the input conditions are connected to each other by a third operator “→”. Needless to mention, the first to third operators are not limited to “or”, “and”, “→”, and can be appropriately selected.

In this logical expression (i), each term (including terms regarded as one term by being enclosed by punctuation marks) that is connected by the first operator “or” becomes a circuit unit, and therefore the edit control unit 25 can specify the circuit units CU₁ and CU₂ based on the data of the logical expression (i). Positions of the circuit units CU₁ and CU₂ in the ladder diagram LD₁ can be specified by the position information described above. Therefore, when the circuit units CU₁ and CU₂ are specified, the connection line IL₁ (see FIG. 2) that connects the output end of the circuit unit CU₁ and the output end of the circuit unit CU₂ can be automatically drawn. The connection line IL₂ (see FIG. 2) that connects the circuit element X5 and the circuit element Y10 is also automatically drawn by the edit control unit 25, in a similar manner to that of the connection line IL₁.

According to the ladder program edition device 60 (see FIG. 1) that edits a ladder diagram in a manner as described above, circuit elements to be connected in parallel with each other in the ladder diagram are specified based on data of a logical expression corresponding to a logical structure in the ladder diagram, and output ends of these circuit elements are automatically connected by connection lines. Therefore, generation of a syntactically erroneous ladder diagram can be easily prevented. Consequently, when the ladder program edition device 60 is used, load when generating a ladder program can be reduced.

After a ladder diagram is logically designed, when circuit elements are positioned in the ladder diagram in the same order as a description order of terms at the time of actually describing a logical structure in the ladder diagram by a logical expression, data of a logical expression corresponding to the logical structure is automatically generated by the edit control unit. Therefore, in this respect, generation of a syntactically erroneous ladder diagram can be also easily prevented.

### Second Embodiment

The ladder program edition device according to the present invention can be added with a function (hereinafter, “arrangement update function”) that automatically updates the arrangement of a circuit element that is nearer to the minus bus bar side than to an edit position and the arrangement of a circuit element at a lower layer side, respectively, when a new circuit element or a circuit block is to be inserted into a desired edit position in a ladder diagram of which editing is once finished or a ladder diagram in the middle of editing, or after a circuit element or a circuit unit arranged at the edit position is deleted. In this case, the circuit block means plural circuit elements that are connected in series with each other (hereinafter, “series circuit block”), or plural circuit elements that are connected in parallel with each other (hereinafter, “parallel circuit block”).

When the arrangement update function described above is added to the ladder program edition device, time and effort required to update or correct a ladder diagram can be substantially omitted, and therefore load when generating a ladder program can be reduced. The ladder program edition device having the arrangement update function can be obtained by adding the arrangement update function to the edit control unit 25 of the ladder program edition device 60 shown in FIG. 1, for example. Therefore, graphic display of this ladder program edition device is omitted here. The arrangement update function is explained in detail below with reference to FIGS. 3 and 4.

FIG. 3 is a schematic diagram of an example of a screen display when a new circuit element is inserted into a ladder diagram in the middle of editing by the ladder program edition device having the arrangement update function. FIG. 3 depicts a state that a new circuit element X4 (see the lower diagram in FIG. 3) is inserted into a ladder diagram LD₂ (see the upper diagram in FIG. 3) after the ladder diagram LD₂ is edited up to a state that three circuit elements X1 to X3 are connected in series in this order from the side of the plus bus bar Mp. Reference sign “AL” in FIG. 3 denotes an auxiliary line.

An edit control unit of the ladder program edition device has already obtained the following logical expression (ii) corresponding to a logical structure of the ladder diagram LD₂ and stores data of the logical expression (ii) in a storage unit.

[Expression 2]

X1 and X2 and X3 (ii)

First, when inserting the new circuit element X4 into the ladder diagram LD₂, a predetermined command is input from an input unit, and an edit position in the ladder diagram LD₂, and an edit type, specifically “insertion”, are assigned, as shown in the upper diagram in FIG. 3. In the example shown in FIG. 3, a hollow arrow drawn at an end of the circuit element X1 at the side of the minus bus bar Bm denotes the edit position and the edit type (insertion). The cell Ce in which the circuit element X1 is arranged is displayed in a color that is different from a color of other cells Ce. To express a difference between display colors of the cells Ce, in the upper diagram in FIG. 3, smudging is given to the cell Ce in which the circuit element X1 is arranged.

When the edit position and the edit type are assigned in this way, the edit control unit updates the above logical expression (ii) to the following logical expression (iii), and stores data of this logical expression into the storage unit.

[Expression 3]

X1 and X4 and X2 and X3 (iii)

Based on data of the logical expression (iii), the edit control unit specifies a circuit element nearer to the minus bus bar Bm (an output side) than to the edit position, and a circuit element at a lower layer side. Because an assigned edit position is an end of the circuit element X1 at the minus bus bar Bm side, that is between the circuit element X1 and the circuit element X2, the edit control unit specifies the circuit elements X2 and X3 as circuit elements nearer to the minus bus bar Bm side (an output side) than to the edit position. There is no circuit element at a lower layer side than the above edit position.

Thereafter, because the edit type is “insertion”, the edit control unit updates position information of the circuit elements X2 and X3 that are specified as described above to position information of cells that are shifted to the minus bus bar Bm side by one cell. Based on this new position information, the edit control unit updates the arrangement of the circuit elements X2 and X3, causes the circuit element X4 to be displayed at the above edit position, and stores position information of the circuit element X4 into the storage unit. As shown in the lower diagram in FIG. 3, a new ladder diagram LD₃ in which the circuit element X4 is arranged between the circuit element X1 and the circuit element X2 is obtained.

FIG. 4 is a schematic diagram of another example of a screen display when a new circuit element is inserted into a ladder diagram in the middle of editing by the ladder program edition device having the arrangement update function. FIG. 4 depicts a state that a new circuit element X4 is inserted into a ladder diagram LD₄ (see the left end diagram in FIG. 4) after the ladder diagram LD₄ is edited up to a state that two circuit elements X1 and X3 that are connected to the plus bus bar Bp are connected in parallel with each other, and the circuit element X2 is connected in series with these two circuit elements X1 and X3. Three circuit elements X1 to X3 are already set as individual circuit units by the edit control unit, and the two circuit elements X1 and X3 are already set as a high-order circuit unit. Reference sign “AL” in FIG. 4 denotes an auxiliary line.

The edit control unit of the ladder program edition device has already obtained the following logical expression (iv) corresponding to a logical structure of the ladder diagram LD₄ and stores data of the logical expression (iv) in the storage unit.

[Expression 4]

(X1 or X3) and X2 (iv)

When inserting the new circuit element X4 into the high-order circuit unit in the ladder diagram LD₄, specifically, at a side of a minus bus bar (not shown) of the circuit element X1, a predetermined command is first input from the input unit, and then an end of the circuit element X1 at a side of a minus bus bar is assigned as an edit position, and “insertion” is assigned as an edit type, as shown in the upper central diagram in FIG. 4. In the example shown in FIG. 4, a hollow arrow drawn at an end of the circuit element X1 at the side of the minus bus bar Bm denotes the edit position and the edit type (insertion). The cell Ce in which the circuit element X1 is arranged is displayed in a color that is different from a color of other cells Ce. In the upper central diagram in FIG. 4, smudging is given to the cell Ce in which the circuit element X1 is arranged.

When the edit position and the edit type are assigned in this way, the edit control unit updates the above logical expression (iv) to the following logical expression (v), and stores data of this logical expression into the storage unit.

[Expression 5]

((X1 and X4) or X3) and X2 (v)

Based on data of the logical expression (v), the edit control unit specifies X2 as a circuit element that is positioned nearer to a side of a minus bus bar (an output side) than to the edit position. There is no circuit element at a side of a lower layer than the above edit position (an insertion position of the circuit element).

Thereafter, because the edit type is “insertion”, the edit control unit updates position information of the circuit element X2 specified as described above to position information of a cell that is shifted to a side of a minus bus bar by one cell. Based on this new position information, the edit control unit updates the arrangement of the circuit element X2, and causes the circuit element X4 to be displayed at the above edit position, as shown in the upper right diagram in FIG. 4. Furthermore, the edit control unit stores position information of the circuit element X4 into the storage unit. Further, the edit control unit sets the circuit element X1 and the circuit element X4 as one circuit unit. The edit control unit then updates a connection line IL₅ that connects an output end of the circuit element X3 and an output end of the circuit element X1 (see the left end diagram and the upper central diagram in FIG. 4) to a connection line IL₆ that connects the output end of the circuit element X3 and an output end of the circuit element X4.

As a result of the above operations, a new ladder diagram LD₅ is obtained in which the circuit element X4 is arranged between the circuit element X1 and the circuit element X2 and in which the output end of the circuit element 4 and the output end of the circuit element X3 are connected to each other by the connection line IL₆. In FIG. 4, to make it easy to distinguish the connection lines IL₅, and IL₆ that connect the output end of the circuit element X3 and an output end of a predetermined circuit element from other connection lines, the connection lines IL₅ and IL₆ are expressed by dashed lines for the sake of convenience.

When inserting the new circuit element X4 between the high-order circuit unit and the circuit element X2 in the ladder diagram LD₄, a predetermined command is first input from the input unit, and, as shown in the lower central diagram in FIG. 4, an end of the high-order circuit unit (the circuit elements X1 and X2) at a side of a minus bus bar is assigned as an edit position and also “insertion” is assigned as an edit type. Accordingly, the cells Ce in which the circuit elements X1 and X2 are arranged are displayed in a color that is different from a color of other cells Ce. In the lower central diagram in FIG. 4, smudging is given to the cells Ce in which the circuit elements X1 and X2 are arranged.

When the edit position and the edit type are assigned in this way, the edit control unit updates the above logical expression (iv) to the following logical expression (vi), and stores data of this logical expression into the storage unit.

[Expression 6]

(X1 or X3) and X4 and X2 (vi)

Based on data of the logical expression (vi), the edit control unit specifies X2 as a circuit element that is positioned nearer to a side of a minus bus bar (an output side) than to the edit position. There is no circuit element at a lower layer side than the above edit position (an insertion position of the circuit element).

Thereafter, because the edit type is “insertion”, the edit control unit updates position information of the circuit element X2 specified as described above to position information of a cell that is shifted to a side of a minus bus bar by one cell, updates the arrangement of the circuit element X2 based on this new position information, causes the circuit element X4 to be displayed at the above edit position, and stores position information of the circuit element X4 into the storage unit. It is unnecessary to update the connection line IL₅ that connects the output end of the circuit element X1 and the output end of the circuit element X3. As a result, as shown in the lower right diagram in FIG. 4, a new ladder diagram LD₆ in which the circuit element X4 is arranged between the high-order circuit unit described above (the circuit elements X1 and X2) and the circuit element X2 is obtained.

In the ladder program edition device that can insert a circuit element as described above, after a ladder diagram is once edited, time and effort required to correct and change the ladder diagram can be reduced. Therefore, load when generating the ladder diagram can be further reduced.

Although graphic display is omitted, a ladder program edition device can be also configured such that the arrangement of each circuit element that is nearer to a side of a minus bus bar than to an edit position and each circuit element at a lower layer side is updated when temporarily inserting a series circuit block or a parallel circuit block into a ladder diagram, in a similar manner to that when inserting a single circuit element into a ladder diagram. In this case, preferably, a predetermined selection screen is displayed on the screen of the display unit such that a user can select an object to be inserted (a circuit element, a series circuit block, or a parallel circuit block) from a list created in advance, for example.

Further, a ladder program edition device having the arrangement update function can be also configured such that when deletion of a predetermined circuit element, circuit block, or circuit unit in a ladder diagram is assigned by a command from the input unit, the ladder program edition device deletes an assigned circuit element, circuit block, or circuit unit, and at the same time, the device specifies a circuit element that is nearer to a side of a minus bus bar than to the deleted circuit element, circuit block, or circuit unit and a circuit element at a lower layer side, and updates corresponding position information and an arrangement in a similar manner to that of “insertion” described above. In this case, the circuit element that is nearer to a side of a minus bus bar than to the deleted circuit element, circuit block, or circuit unit is shifted to a side of a plus bus bar in a cell unit, and the circuit element at a lower layer side is shifted to a higher layer side in a cell unit.

### Third Embodiment

The ladder program edition device according to the present invention can be added with a function (hereinafter, “insertion guide function”) that causes the display unit to visually display an editable position at which a new circuit element or a circuit block can be connected when the new circuit element or the circuit block is inserted into a ladder diagram of which editing is once finished or a ladder diagram in the middle of editing.

When the insertion guide function described above is added to the ladder program edition device, it becomes easy to prevent insertion of a circuit element or a circuit block into a syntactically erroneous position when changing or correcting a ladder diagram. Therefore, load when generating a ladder program can be further reduced. The ladder program edition device having the insertion guide function can be obtained by adding the insertion guide function to the edit control unit 25 of the ladder program edition device 60 shown in FIG. 1, for example. Therefore, graphic display of this ladder program edition device is omitted here. The insertion guide function is explained in detail below with reference to FIGS. 5 to 7.

FIG. 5 is a schematic diagram of an example of a screen display when a new circuit element is inserted into a ladder diagram in the middle of editing by the ladder program edition device having the insertion guide function. FIG. 5 depicts a ladder diagram LD₁₁ that is configured by three circuit units CU₁₁ to CU₁₃ and the circuit element Y10. In FIG. 5, reference sign “AL” denotes an auxiliary line, and reference sign “Ce” denotes a cell.

Among the three circuit units CU₁₁ to CU₁₃ described above, the circuit unit CU₁₁ is constituted by two circuit elements X1 and X4 that are connected to the plus bus bar Bp, and these circuit elements X1 and X4 are connected in parallel with each other by a connection line IL₁₁. The circuit unit CU₁₂ is constituted by the circuit unit CU₁₁, the circuit element X2 that is connected in series with the circuit unit CU₁₁, and the circuit element X3 that is connected in series with the circuit element X2. The circuit unit CU₁₃ is constituted by the circuit element X5 that is connected to the plus bus bar Bp, and the circuit element X6 that is connected in series with the circuit element X5. The circuit unit CU₁₃ is connected in parallel with the circuit unit CU₁₂ by a connection line IL₁₂.

The circuit element Y10 is connected to the circuit unit CU₁₂ by a connection line IL₁₃, and the circuit element Y10 is also connected to the minus bus bar Bm. In FIG. 5, to make it easy to distinguish the connection lines IL₁₁ to IL₁₃ from other connection lines, the connection lines IL₁₁ to IL₁₃ are expressed by dashed lines for the sake of convenience.

The edit control unit of the ladder program edition device has already obtained the following logical expression (vii) corresponding to a logical structure of the ladder diagram LD₁₁ and stores data of the logical expression (vii) in the storage unit.

[Expression 7]

((X1 or X4) and X2 and X3) or (X5 and X6)→Y10 (vii)

The storage unit stores information (hereinafter, “edit specification information”) related to a connection relation that is permitted when editing a ladder diagram in advance. The edit specification information indicates, for example, that regarding a circuit element and a circuit unit related to an input condition, another circuit element or another circuit block can be connected in four directions at a side of a plus bus bar, a side of a minus bus bar, an upper layer side, and a lower layer side, and indicates that regarding a circuit element and a circuit unit related to an output condition, another circuit element or another circuit block can be connected in three directions at a side of a plus bus bar, an upper layer side, and a lower layer side.

When any of the circuit units CU₁₁ to CU₁₃, or the circuit element Y10 is assigned and also when “insertion” is assigned as an edit type by a command from the input unit, the edit control unit causes the display unit to visually display an editable position at which another circuit element or another circuit unit can be connected to an assigned circuit unit or the circuit element Y10, based on the edit specification information described above. In FIG. 5, for each of the circuit units CU₁₁ to CU₁₃, and the circuit element Y10, an editable position at which another circuit element or another circuit block can be connected is shown by a hollow arrow. Thereafter, when one of editable positions that are visually displayed is selected by a command from the input unit, the edit control unit inserts a circuit element or a circuit block into the editable position, and updates the ladder diagram LD₁₁ to a new ladder diagram.

For example, when the circuit unit CU₁₁ is assigned and also when “insertion” of the circuit element X7 is instructed by a command from the input unit, when four hollow arrows in total are visually displayed around the circuit unit CU₁₁, and also when an arrow at a side of the plus bus bar Bp is selected from among the four hollow arrows, the edit control unit updates the above logical expression (viii) to the following logical expression (viii), and stores data of the logical expression (viii) into the storage unit.

[Expression 8]

((X7 and (X1 or X4) and X2 and X3) or (X5 and X6)→Y10 (viii)

Based on the data of the logical expression (viii), position information and an arrangement of the circuit elements X1 to X4 are respectively updated to the side of the minus bus bar Bm by one cell by the arrangement update function explained in the second embodiment, and at the same time, the circuit element X7 is inserted between the circuit element X1₁ and the plus bus bar Bp. Further, a connection line between circuit units that are connected in parallel with each other is updated.

As a result of these operations, the ladder diagram LD₁₁ shown in FIG. 5 is updated to a ladder diagram LD₁₂ shown in FIG. 6. In the ladder diagram LD₁₂, a connection line IL₁₄ that connects an input end of the circuit element X1 and an input end of the circuit element X4 is automatically drawn by the edit control unit. In FIG. 6, the connection line IL₁₄ is also displayed by a dashed line for the sake of convenience.

When the circuit unit CU₁₁ is assigned and also when “insertion” of the circuit element X7 is instructed in the ladder diagram LD₁₁ shown in FIG. 5, when the four hollow arrows in total are visually displayed around the circuit unit CU₁₁, and also when an arrow at an upper layer side is selected from among the four hollow arrows, the edit control unit updates the logical expression (vii) mentioned above to the following logical expression (ix), and stores data of the logical expression (ix) into the storage unit.

[Expression 9]

((X7 or X1 or X4) and X2 and X3) or (X5 and X6)→Y10 (iv)

Based on the data of the logical expression (ix), position information and an arrangement of the circuit elements X1, X2, X5, and X6 are respectively updated to a side of a lower layer by one cell by the arrangement update function explained in the second embodiment, and at the same time, the circuit element X7 is inserted between the plus bus bar Bp and the circuit element X2. Further, a connection line between circuit units that are connected in parallel with each other is updated.

As a result, the ladder diagram LD₁₁ shown in FIG. 5 is updated to a ladder diagram LD₁₃ shown in FIG. 7. In the ladder diagram LD₁₃, the connection line IL₁₁ that connects an output end of the circuit element X4 and an output end of the circuit element X1 in the ladder diagram LD₁₁ in FIG. 5 is extended to an upper layer side, and connects the output end of the circuit element X4 and an output end of the circuit element X7.

### Fourth Embodiment

The ladder program edition device according to the present invention can be added with a function (hereinafter, “skip function”) that causes an edit position to be shifted to a nearest circuit element along a predetermined direction when the shift of the edit direction to this direction is instructed by a command from the input unit. The ladder program edition device having the skip function can be obtained by adding the functions mentioned above to the edit control unit 25 of the ladder program edition device 60 shown in FIG. 1, for example. Therefore, graphic display of this ladder program edition device is omitted here. The skip function is explained in detail below with reference to FIG. 8.

FIG. 8 is a schematic diagram of an example of an edit-position shifting mode of the ladder program edition device having the skip function. FIG. 8 depicts a ladder diagram LD₁₅ in which an input condition is specified by the circuit element X1 that is connected to the plus bus bar Bp, and the circuit element Y10 that specifies an output condition by being connected to the minus bus bar Bm is connected in series with the circuit element X1. In FIG. 8, reference sign “AL” denotes an auxiliary line, and reference sign “Ce” denotes a cell.

The edit control unit of the ladder program edition device has already obtained the following logical expression (x) and stores data of the logical expression (x) in the storage unit. The edit control unit also stores respective position information of the circuit elements X1 and Y10 in the storage unit.

[Expression 10]

X1→Y10 (x)

When a command that instructs shifting an edit position to the side of the minus bus bar Bm is input from the input unit when the circuit element X1 is being assigned in the ladder diagram LD₁₅, the edit control unit specifies a nearest circuit element nearer to the side of the minus bus bar Bm (an output side) than to the circuit element X1, that is, the circuit element Y10, based on the above logical expression (x), and causes the edit position to be shifted to the circuit element Y10 as shown by a hollow arrow in FIG. 8, based on the position information of the circuit element Y10. As compared with a case of shifting an edit position in a cell unit, an operation and time that are required to shift the edit position can be substantially shortened.

A ladder program edition device can be also configured such that when a command that instructs shifting an edit position to an upper layer side or a lower layer side is input from the input unit, the device specifies a nearest circuit element in only a cell row that includes the current edit position and causes the edit position to be shifted to the circuit element. However, preferably, the ladder program edition device is configured such that the device specifies a nearest circuit element in all cell rows and causes an edit position to be shifted to the circuit element.

### Fifth Embodiment

The ladder program edition device according to the present invention can be added with a function (hereinafter, “omission display function”) that replaces an assigned circuit block with a predetermined sign and also causes the display unit to perform visual display that indicates that omission display is being performed when the omission display of a predetermined circuit block (including a circuit unit) is instructed by a command from the input unit. The ladder program edition device having the omission display function can be obtained by adding the omission display function to the edit control unit 25 of the ladder program edition device 60 shown in FIG. 1, for example. Therefore, graphic display of this ladder program edition device is omitted here. The omission display function is explained in detail below with reference to FIG. 9.

FIG. 9 is a schematic diagram, shown by a transition of a screen display of the display unit, of an example of the omission display function of the ladder program edition device having the omission display function. In FIG. 9, in the upper diagram, a ladder diagram LD₂₁ before using the omission display function is shown, and in the lower diagram, a ladder diagram LD₂₂ in which omission of a part of circuit blocks in the ladder diagram LD₂₁ is displayed by the omission display function is shown. In FIG. 9, reference sign “Bp” denotes a plus bus bar, reference sign “Bm” denotes a minus bus bar, reference sign “AL” denotes an auxiliary line, and reference sign “Ce” denotes a cell.

In the ladder diagram LD₂₁ described above, an input condition is specified by a circuit unit CU₂₁ that is configured by 100 circuit elements in total of X1 to X100 and one circuit element X999 that is connected in parallel with the circuit unit CU₂₁. When omission display of the circuit unit CU₂₁ as a circle block is instructed by a command from the input unit, the edit control unit of the ladder program edition device performs omission display of the circuit unit CU₂₁ by letter S represented by a rectangle having a size to be accommodated in one cell row, and displays a message of “+ circuit unit not displayed” in the letter S, thereby visually displaying omission display of the circuit unit CU₂₁ and changing the ladder diagram LD₂₁ to the ladder diagram LD₂₂. When this omission display is performed, the entire configuration of the ladder diagram can be easily understood even when circuit units before the omission display cannot be sufficiently accommodated in the screen of the display unit in many cell rows.

### Sixth Embodiment

The ladder program edition device according to the present invention can be added with a function (hereinafter, “circuit-unit assignment function”) that sets mutually adjacent circuit elements as a circuit unit and updates data of a logical expression when the setting of the mutually adjacent circuit elements as a circuit unit is instructed by a command from the input unit. Specifically, the ladder program edition device can be added with the circuit-unit assignment function that sets selected circuit elements as one circuit unit when mutually adjacent circuit elements are selected from among three or more circuit elements that are connected in series with each other or from among three or more circuit elements that are connected in parallel with each other.

The ladder program edition device having the circuit-unit assignment function can be obtained by adding the circuit-unit assignment function to the edit control unit 25 of the ladder program edition device 60 shown in FIG. 1, for example. Therefore, graphic display of this ladder program edition device is omitted here. The circuit-unit assignment function is explained in detail below with reference to FIG. 10.

FIG. 10 is a schematic diagram of an example of a transition of a screen display of the ladder program edition device having the circuit-unit assignment function. In the left diagram in FIG. 10, a ladder diagram LD₂₅ is shown in which three circuit elements X1 to X3 are connected in series in this order from the side of the plus bus bar Mp and these circuit elements are already set as one circuit unit CU₂₅ by the edit control unit, and in which mutually adjacent two circuit elements X2 and X3 in these three circuit elements X1 to X3 are selected as constituent elements of a new circuit unit.

Selection of circuit elements that serve as constituent elements of a new circuit unit is made, for example, by inputting a predetermined command from the input unit and by assigning each circuit element that serves as a constituent element of the new circuit unit. In the example shown in FIG. 10, the cells Ce in which the circuit elements X1 and X2 selected as constituent elements of the new circuit unit are arranged are displayed in a color that is different from a color of other cells Ce. To express a difference between display colors of the cells Ce, in FIG. 10, smudging is given to the cells Ce in which the circuit elements X1 and X2 are arranged.

Thereafter, when a command that instructs setting the selected circuit elements X1 and X2 as one circuit unit is input from the input unit, the edit control unit sets the circuit elements X1 and X2 as one circuit unit CU₂₆. Following this setting, the edit control unit obtains the following logical expression (xi), and stores data of the logical expression (xi) into the storage unit.

[Expression 11]

(X1 and X2) and X3 (xi)

Therefore, two circuit units CU₂₅ and CU₂₆ are present afterwards in the ladder diagram LD₂₅.

Therefore, as shown in the right diagram in FIG. 10, for example, when the circuit element X4 is inserted in parallel with the circuit unit CU₂₆, the edit control unit obtains the following logical expression (xii), and stores data of the logical expression (xii) into the storage unit.

[Expression 12]

((X1 and X2) or X4) and X3 (xii)

As a result, a ladder diagram LD₂₆ in which four circuit units in total of CU₂₆ to CU₂₉ are arranged in a nest shape is obtained. The circuit unit CU₂₇ in the ladder diagram LD₂₆ is constituted by the circuit element X4. The circuit unit CU₂₈ is constituted by the circuit units CU₂₆ and CU₂₇ that are connected in parallel with each other by a connection line IL₂₅. The circuit unit CU₂₉ is constituted by the circuit unit CU₂₈ and the circuit element X3 that is connected to the circuit unit CU₂₈₇ in series.

When the circuit-unit assignment function is used, a ladder diagram can be edited as described above. Therefore, according to the ladder program edition device having the circuit-unit assignment function, correction or change of a once-edited ladder diagram or a ladder diagram in the middle of editing becomes easy.

Although the ladder program edition device according to the present invention has been explained above by exemplifying embodiments, as described above, the present invention is not limited to the above embodiments. The ladder program edition device according to the present invention is basically workable as far as the device has a function that causes circuit elements that constitute a ladder diagram to be symbolically displayed in a predetermined cell on a screen of a display unit, generates data of a logical expression corresponding to a logical structure in the ladder diagram based on an arrangement of the circuit elements, and specifies circuit elements to be connected in parallel with each other in the ladder diagram and connects output ends of the circuit elements by a connection line based on data of the logical expression. Selection of the kind of functions to be added other than this basic function can be made as appropriate. Therefore, in the ladder program edition device according to the present invention, changes, modifications, and combinations other than those described in the above embodiments can be made.

### INDUSTRIAL APPLICABILITY

The ladder program edition device according to the present invention can be suitably used for editing a ladder program that determines a control sequence by a sequencer in a form of a ladder diagram.

1.-8. (canceled)

9. A ladder program edition device that causes a plus bus bar and a minus bus bar in a ladder diagram to be displayed on a screen of a display unit, causes a plurality of auxiliary lines to be vertically and laterally displayed in a region between the plus bus bar and the minus bus bar, thereby partitioning the region into a plurality of cells, causes circuit elements that constitute a ladder diagram to be symbolically displayed in mutually separate cells, and edits a ladder diagram in which at least one input condition corresponds to one output condition, the ladder program edition device comprising:
an input unit that inputs a command related to editing of the ladder diagram; and
an edit control unit that arranges the circuit elements in cells on the screen of the display unit based on a command from the input unit, generates data of a logical expression corresponding to a logical structure in the ladder diagram by specifying an aggregate of the arranged circuit elements in each row as a circuit unit to be connected in parallel with each other, specifies circuit elements to be connected in parallel with each other in the ladder diagram based on the data of the logical expression, and connects output ends of the circuit elements by a connection line.

10. The ladder program edition device according to claim 9, wherein when insertion of a circuit element or a circuit block at a predetermined edit position in the ladder diagram or deletion of a circuit element or a circuit block at a predetermined edit position in the ladder diagram is instructed by a command from the input unit, the edit control unit specifies a circuit element nearer to a side of the minus bus bar than to the edit position and a circuit element nearer to a lower layer side than to the edit position among circuit elements that specify the input condition, and updates an arrangement of the specified circuit element in the ladder diagram.

11. The ladder program edition device according to claim 10, wherein when insertion of a circuit element or a circuit block at a predetermined edit position in the ladder diagram is instructed by a command from the input unit, the edit control unit controls such that, among circuit elements that specify the input condition, a circuit element nearer to a side of the minus bus bar than to the edit position is shifted to the minus bus bar side in a cell unit and a circuit element nearer to a lower layer side than to the edit position is shifted to the lower layer side in a cell unit.

12. The ladder program edition device according to claim 10, wherein when deletion of a predetermined circuit element or circuit block in the ladder diagram is instructed by a command from the input unit, the edit control unit deletes the circuit element or the circuit block, and causes a circuit element nearer to a side of the minus bus bar than to the deleted circuit element to be shifted to a side of the plus bus bar in a cell unit and causes a circuit element at a lower layer side than to the deleted circuit element to be shifted to an upper layer side in a cell unit, among circuit elements that specify the input condition.

13. The ladder program edition device according to claim 10, wherein when a predetermined circuit element or circuit block in the ladder diagram is assigned and also when insertion of another circuit element or a circuit block is instructed by a command from the input unit, the edit control unit causes the display unit to visually display an editable position at which the another circuit element or circuit block can be connected in series and in parallel to a circuit unit that is configured to include the assigned circuit element or circuit block.

14. The ladder program edition device according to claim 10, wherein when shifting of an edit position to a predetermined direction is instructed by a command from the input unit, the edit control unit causes the edit position to be shifted to a nearest circuit element along the instructed direction.

15. The ladder program edition device according to claim 10, wherein when omission display of a predetermined circuit block is instructed by a command from the input unit, the edit control unit replaces the assigned circuit block with a predetermined sign and also causes the display unit to perform visual display that indicates that omission display is being performed.

16. The ladder program edition device according to claim 10, wherein when setting mutually adjacent circuit elements as a circuit unit is instructed by a command from the input unit, the edit control unit sets the mutually adjacent circuit elements as a circuit unit and updates data of the logical expression.
